(19) United States
(12) Patent Application Publication
(10) Pub. No.: US 2012/0219702 A1
(43) Pub. Date: Aug. 30, 2012

(54) NANOMATERIAL-BASED FILMS PATTERNED USING A SOLUBLE COATING

(76) Inventors: Graeme Scott, Maynooth (IE); Lorraine Byrne, Dublin (IE); Richard Coull, Dundalk (IE); Vittorio Scardaci, Dublin (IE)

(21) Appl. No.: 13/034,223

(22) Filed: Feb. 24, 2011

(51) Int. Cl. B05D 5/12; B05C 5/00; B82Y 30/00

(52) U.S. Cl. 427/79; 118/719; 427/58; 427/102; 427/122; 427/125; 977/936; 977/932; 977/939; 977/742

(57) ABSTRACT

A film can be patterned with a nanomaterial. Such patterning can, in various embodiments, be performed by applying a uniform mixture of a solute in a solvent to a surface of the film to form a coating of a soluble material on the surface of the film in a pre-defined pattern that defines coated parts of the film and uncoated parts of the film, depositing an aqueous dispersion, including the nanomaterial and a surfactant, on the defined coated and uncoated parts of the film, washing the film to remove the coating of the soluble material and the nanomaterial from the defined coated parts of the film, but not removing the nanomaterial from the defined uncoated parts of the film, along with removing the surfactant from the defined coated and uncoated parts of the film, and leaving a pattern of the nanomaterial on the defined uncoated parts of the film.

### BACKGROUND

Nanomaterials, such as carbon nanotubes (CNTs), demonstrate unique electrical properties and flexibility, making them useful in modern electronic devices. For instance, nanomaterials can be found in devices that require a flexible transparent conductor, such as displays and photovoltaic cells. These devices require that nanomaterials be patterned, as do other devices employing nanomaterials. Unfortunately, many of the properties making nanomaterials useful often make them expensive.

### BRIEF DESCRIPTION OF THE DRAWINGS

FIG. 1 is a block diagram illustrating an example of a method of patterning nanomaterial on a film according to the present disclosure.

FIG. 2 is a block diagram illustrating an example of a method of forming an electronic device by patterning carbon nanotubes on a film according to the present disclosure.

FIGS. 3A-3C illustrate an example of a system of forming a pattern of carbon nanotubes on a film according to the present disclosure.

### DETAILED DESCRIPTION

Electronic devices using nanomaterials (e.g., CNTs) exhibit benefits such as flexibility, transparency, and strength. These types of electronic devices can be circuits that include conductors, resistors, capacitors, inductors, and/or transistors, among other electronic components. However, as valuable as these devices are likely to be, the difficulty of patterning with nanomaterials, including CNTs, may add to manufacturing costs. Patterning electronic devices from nanomaterials may require precision processing techniques, such as photolithography and viscosity control, requiring multiple steps and/or added chemicals (e.g., developer, among others). The multiple steps and/or added chemicals involved in these processing techniques may increase the associated costs, may cause damage to the nanomaterials and/or a substrate upon which the nanomaterials are deposited, or both.

Embodiments of the present disclosure include patterning nanomaterial on a film. Such patterning can, in various embodiments, be performed by applying a uniform mixture of a solute in a solvent to a surface of the film to form a coating of soluble material on the surface of the film in a pre-defined pattern that defines coated parts of the film and uncoated parts of the film, depositing an aqueous dispersion, comprising a nanomaterial and a surfactant, on the defined coated and uncoated parts of the film, washing the film to remove the coating of soluble material and the nanomaterial from the defined coated parts of the film, but not removing the nanomaterial from the defined uncoated parts of the film, along with removing the surfactant from the defined coated and uncoated parts of the film. Doing so leaves a pattern of nanomaterial on the defined uncoated parts of the film.

In the following detailed description of the present disclosure, reference is made to the accompanying drawings that form a part hereof, and in which is shown by way of illustration how examples of the disclosure may be practiced. These examples are described in sufficient detail to enable those of ordinary skill in the art to practice the embodiments of this disclosure. It is to be understood that other examples may be utilized and that process, electrical, and/or structural changes may be made without departing from the scope of the present disclosure.

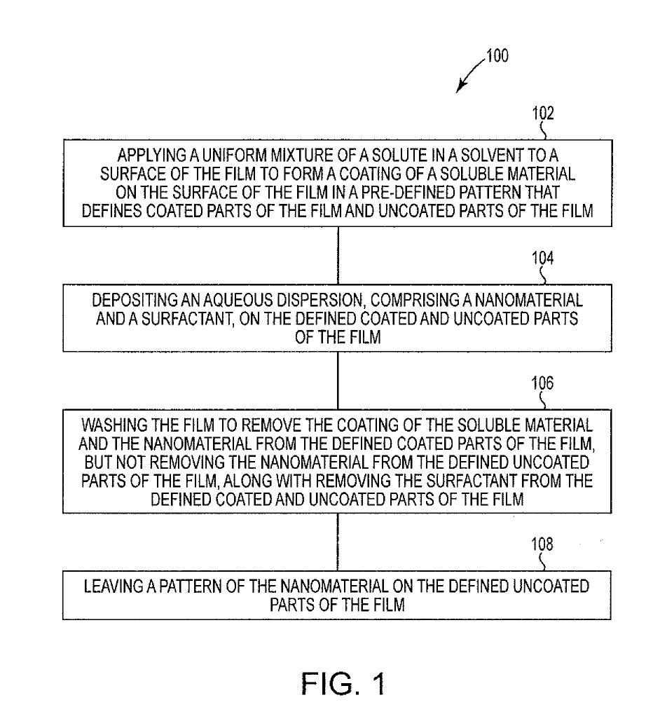

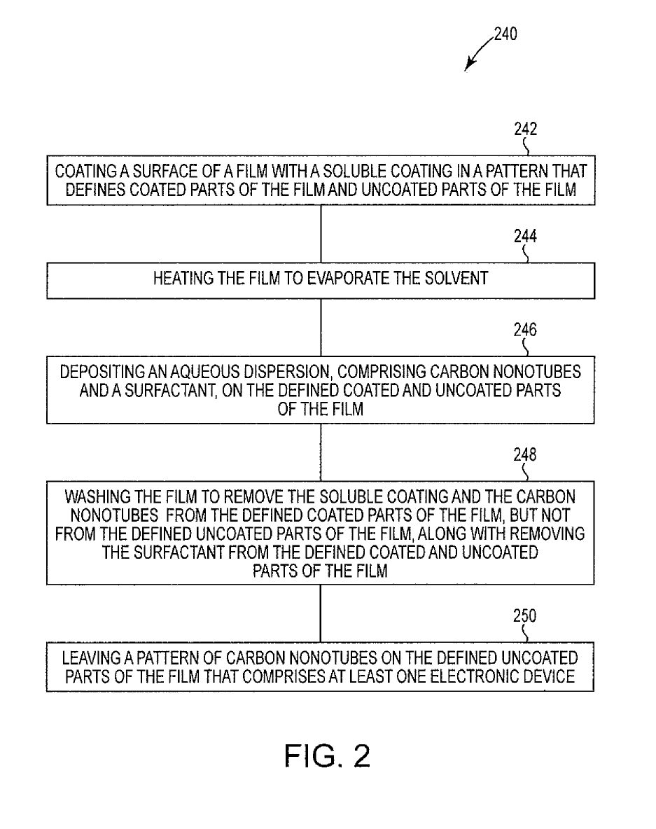

The figures herein follow a numbering convention in which the first digit or digits correspond to the drawing figure number and the remaining digits identify an element or component in the drawing. Similar elements or components between different figures may be identified by the use of similar digits. For example 104 may reference element “04” in FIG. 1, and a similar element may be referenced as 204 in FIG. 2. Elements shown in the various figures herein can be added, exchanged, and/or eliminated so as to provide a number of additional examples of the present disclosure. In addition, the proportion and the relative scale of the elements provided in the figures are intended to illustrate the examples of the present disclosure and should not be taken in a limiting sense.

FIG. 1 is a block diagram illustrating an example of a method 100 of patterning nanomaterial according to the present disclosure. Unless explicitly stated, the method embodiments described herein are not constrained to a particular order or sequence. Additionally, some of the described method embodiments, or elements thereof, can occur or be performed at the same, or substantially the same, point in time.

Patterning nanomaterial includes applying a uniform mixture of a solute in a solvent to a surface of the film to form a coating of soluble material on the surface of the film in a pre-defined pattern that defines coated parts of the film and uncoated parts of the film, as shown in block 102 of FIG. 1. Forming a coating of soluble material on the surface of the film in a pre-defined pattern, as used herein, can include using a printer such as gravure, screen, thermal inkjet, and/or piezoelectric inkjet, among other types of printers.

Solute and solvent, as used herein, can be referred to in their combined state or individually. For example, polyvinyl alcohol (a solute) can be dissolved in propan-2-ol (a solvent). The solution formed thereby may be referred to industrially as Universal Protective Coating (UPC). In various embodiments, UPC can be used to form a coating of soluble material. Solute and solvent, as used herein, can also refer to combinations of more than one solute and/or more than one solvent. For example, water soluble ink can be used in forming a coating of soluble material as used herein. In some water soluble inks, water is the solvent and various solutes may be dissolved therein (e.g., pigments and/or dyes).

Forming a coating of soluble material on the surface of the film in a pre-defined pattern can include applying the uniform mixture in the pre-defined pattern to a desired thickness. For example, the uniform mixture can be applied to a thickness in a range of from 1 micrometer to 15 micrometers.

Patterning on a film, as used herein, can refer to, for example, patterning with a coating on a surface of a polyester-based film. Examples of polyester-based films include, but are not limited to, films comprising a thermoplastic polymer resin such as polyethylene terephthalate (PET) and/or polyethylene naphthalate (PEN). The film, as used herein, can range from transparent to opaque and from rigid to highly flexible.

As shown in block 104 of FIG. 1, an aqueous dispersion, comprising a nanomaterial and a surfactant, is deposited on the defined coated and uncoated parts of the film. Examples of nanomaterials, as used herein, can include, but are not limited to, CNTs, silver nanowires, graphene flakes, and/or graphene ribbons. The aqueous dispersion comprising the nanomaterial and the surfactant can be obtained, for example, by sonification and centrifugation to break up nanomaterial bundles. In the example of CNTs, the surfactant within the aqueous dispersion can prevent the CNTs from rebundling. The percent of the aqueous dispersion by volume that is surfactant can vary according to, for example, the proportion of nanomaterial to water, temperature, and/or the degree to which the nanomaterial was debundled using sonification and centrifugation, among other considerations, although the percentage can be selected so as to exceed the critical micelle concentration. For example, depositing the surfactant in the aqueous dispersion can include depositing sodium dodecyl sulfate in a range of from 0.2% to 2.0% by volume.

Depositing the aqueous dispersion, comprising nanomaterial (e.g., CNTs) and a surfactant, on the defined coated and uncoated parts of the film can include, for example, depositing the aqueous dispersion such that the CNTs and surfactant are deposited to a uniform thickness. Depositing the aqueous dispersion, comprising CNTs and a surfactant, on the defined coated and uncoated parts of the film can also include, for example, depositing the aqueous dispersion such that the CNTs and surfactant are deposited to a desired thickness that is non-uniform. For example, the aqueous dispersion can be deposited to a thickness in a range of from 2.5 to 150 nanometers. Depositing the aqueous dispersion to a desired thickness can include, for example, aerosol spraying the aqueous dispersion to the desired uniform or non-uniform thickness.

Depositing the aqueous dispersion, comprising nanomaterial and a surfactant, on the defined coated and uncoated parts of the film can include heating the film to evaporate the water contained in the aqueous dispersion. Applying a uniform mixture of a solute in a solvent to a surface of the film to form a coating of a soluble material on the surface of the film in a pre-defined pattern, as described above, can include heating the film to evaporate the solvent. Heating, as used herein, can refer to conduction, convection, radiation, and combinations thereof.

Heating the film to evaporate the water contained in the aqueous dispersion and/or heating the film to evaporate the solvent from the coating of soluble material can include heating for a pre-determined time period to allow the solvent and/or water to fully evaporate from the film. The time required for evaporation can depend, for example, on the surfactant(s) applied, the proportion(s) of surfactants(s) to water and/or nanomaterial, the surface area of the film, and the thickness of the aqueous dispersion deposited, the solvent(s) applied, the solute(s) applied, the proportion(s) of solute(s) to solvent(s), the surface area of the film, the surface area of the film to which the solute(s) and solvent(s) were applied, and the thickness of the coating of soluble material, among other considerations. In various embodiments, the film can be heated to a temperature in a range of from 30 to 100 degrees Celsius to evaporate the solvent from the coating of soluble material before depositing the aqueous dispersion, as described above.

Patterning nanomaterial can include washing the film to remove the coating of soluble material and the nanomaterial from the defined coated parts of the film, but not removing the nanomaterial from the defined uncoated parts of the film, along with removing the surfactant from the defined coated and uncoated parts of the film, as shown in block 106 of FIG. 1. Washing the film can include, for example, washing the film with a solvent (e.g., de-ionized water) for the soluble material and the surfactant. Washing the film can include spraying, dipping, dunking, rinsing, laving and/or soaking, among other techniques for washing.

Washing the film can include removal of the soluble material (e.g., the solute), the surfactant, and nanomaterial from the coated parts of the film. Washing the film can also include allowing the film to air dry (e.g., by exposure to ambient or higher temperature and/or to air flow). For example, the film is washed with de-ionized water that dissolves the water-soluble surfactant and water-soluble solute. CNTs dispersed upon the defined solute-coated parts of the film are washed off the film when the solute upon which they were deposited dissolves. The film with the patterned CNTs can then be dried (e.g., air dried).

As shown in block 108 of FIG. 1, a pattern of nanomaterial is left on the defined uncoated parts of the film. Leaving the pattern of nanomaterial on the film can include forming an electronic device. An electronic device, as used herein, can include a conductor, a resistor, a capacitor, an inductor, and/or a transistor, among others. The shape of the pattern of nanomaterial removed from and left on the film can depend on and can determine the particular electronic device to be formed.

Example method 100, illustrated in FIG. 1, can also include collecting nanomaterial washed from the surface of the film. Nanomaterial collected can be reused and/or redispersed (e.g., in accordance with depositing an aqueous dispersion) as the nanomaterial and a surfactant on the defined coated and uncoated parts of the same or another film, according to block 104 of FIG. 1.

FIG. 2 is a block diagram illustrating an example of a method 240 of forming an electronic device by patterning CNTs on a film according to the present disclosure. As shown in block 242, a surface of the film is coated with a soluble coating in a pattern that defines coated parts of the film and uncoated parts of the film.

The film is heated to evaporate the solvent, as shown in block 244. As shown in block 246, an aqueous dispersion, comprising CNTs and a surfactant, is deposited on the defined coated and uncoated parts of the film.

Forming an electronic device can include washing the film to remove the soluble coating and the CNTs from the defined coated parts of the film, but not removing the nanomaterial from the defined uncoated parts of the film, along with removing the surfactant from the defined coated and uncoated parts of the film, as shown in block 248 of FIG. 2.

As shown in block 250, a pattern of CNTs is left on the defined uncoated parts of the film that comprises at least one electronic device. The electronic device that is left on the film can be, for example, an electronic circuit that includes a number of conductors, resistors, capacitors, inductors, and/or transistors, among other components.

Example method 240 illustrated in FIG. 2 may also include collecting CNTs washed from the surface of the film. CNTs collected may be reused and/or redispersed (e.g., in accordance with depositing an aqueous dispersion) as CNTs and a surfactant on the defined coated and uncoated parts of the same or another film, according to block 246 of FIG. 2.

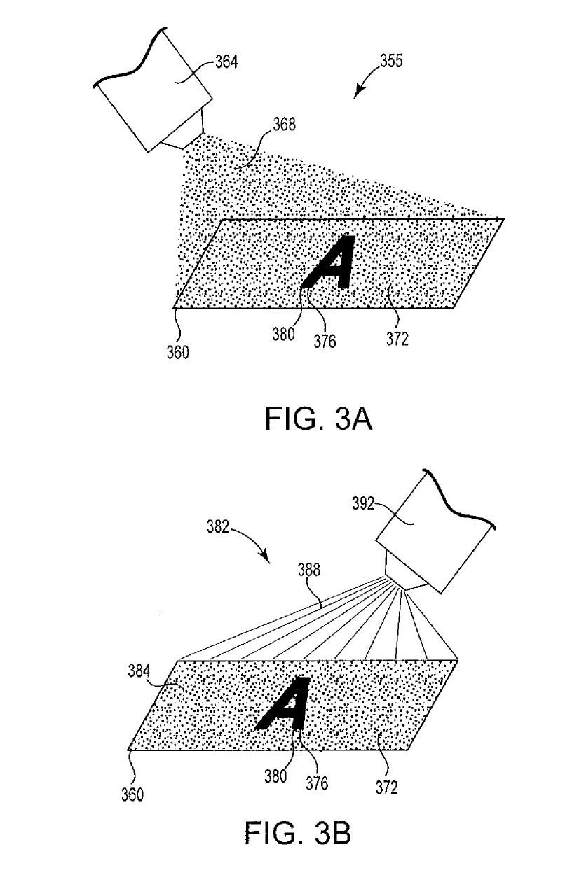

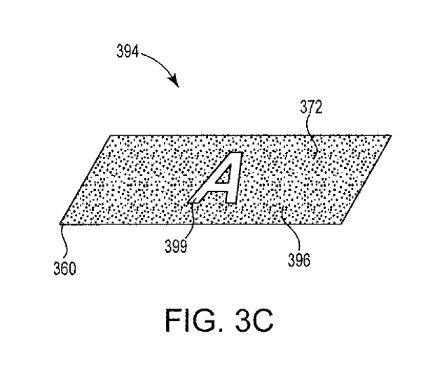

FIGS. 3A-3C illustrate an example of a system of forming a pattern of carbon nanotubes on a film according to the present disclosure. Referring to FIG. 3A, diagram 355 illustrates, by way of example and not by way of limitation, the film 360 coated in a pattern with a soluble coating 376 in a pre-defined pattern that defines coated parts 380 of the film 360 and uncoated parts 372 of the film 360. As previously described, coating the surface of film 360 with soluble coating 376 can include, for example, using a printer such as gravure, screen, thermal inkjet, and piezoelectric inkjet. Coating the surface of the film 360 can include applying soluble coating 376 to a desired thickness. For example, the soluble coating 376 can be applied to a thickness in a range of from 1 micrometer to 15 micrometers.

A spray apparatus 364 deposits an aerosol dispersion 368 of CNTs and a surfactant on the defined coated parts 380 and defined uncoated parts 372 of the film 360. As previously described, spray apparatus 364 can deposit the aerosol dispersion 368 on the defined coated parts 380 and defined uncoated parts 372 of the film 360 such that the CNTs and surfactant are deposited to a desired thickness that is uniform or non-uniform across the surface of the film 360. For example, spray apparatus 364 can deposit the aerosol dispersion 368 such that the CNTs and surfactant are deposited to a thickness in a range of from 2.5 to 150 nanometers.

Referring to FIG. 3B, diagram 382 illustrates, by way of example and not by way of limitation, the film 360 with the deposited CNT-plus-surfactant aerosol dispersion 384 over the defined coated parts 380 and defined uncoated parts 372 of the film 360. A washing apparatus 392 removes the soluble coating 376 and the CNTs deposited on the defined coated parts 380 of the film 360, along with the surfactant deposited on the defined coated parts 380 and defined uncoated parts 372 of the film 360, by washing the film with a washing solvent 388. The washing solvent 388 can be a solvent that dissolves the soluble coating 376 and the surfactant of the deposited aerosol dispersion 384. The washing solvent 388 can, for example, be de-ionized water.

Referring to FIG. 3C, diagram 394 illustrates, by way of example and not by way of limitation, a pattern 396 of CNTs left on the defined uncoated parts 372 of the film 360 following removal of the soluble coating. A pre-defined pattern 399 from which the CNTs have been removed, along with the soluble coating, can define, for example, a representation of an area between electronic devices that has high resistance.

The example system illustrated in FIGS. 3A-3C can also include a collection apparatus that collects the removed CNTs washed from the surface of the film 360 by the washing apparatus 392. The collected CNTs may be reused and/or redispersed, for example, by being reintroduced, directly or indirectly, into the spray apparatus 364 for use in the aerosol dispersion 368.

In conclusion, while the present disclosure has been particularly shown and described with reference to various embodiments, those skilled in the art will understand that many variations may be made herein without departing from the spirit and scope of the disclosure as defined in the following claims. This disclosure should be understood to include the novel and non-obvious combinations of elements described herein, and claims may be presented in this or a later application to any novel and non-obvious combination of these elements. The foregoing embodiments are illustrative, and no single feature or element is essential to all possible combinations that may be claimed in this or a later application. Whereas the claims recite “a” or “a first” element or the equivalent thereof, such claims should be understood to include incorporation of one or more such elements, neither requiring nor excluding two or more such elements.

What is claimed is:

1. A method of patterning on a film comprising:
applying a uniform mixture of a solute in a solvent to a surface of the film to form a coating of a soluble material on the surface of the film in a pre-defined pattern that defines coated parts of the film and uncoated parts of the film;
depositing an aqueous dispersion, comprising a nanomaterial and a surfactant, on the defined coated and uncoated parts of the film;
washing the film to remove the coating of the soluble material and the nanomaterial from the defined coated parts of the film, but not removing the nanomaterial from the defined uncoated parts of the film, along with removing the surfactant from the defined coated and uncoated parts of the film; and
leaving a pattern of the nanomaterial on the defined uncoated parts of the film.

2. The method of claim 1, where patterning on the film includes patterning on a surface of a polyester-based film.

3. The method of claim 1, where applying the solute includes applying polyvinyl alcohol as the solute.

4. The method of claim 1, where applying the solvent includes applying propan-2-ol as the solvent.

5. The method of claim 1, where the method includes heating the film to a temperature in a range of from 30 to 100 degrees Celsius to evaporate the solvent before depositing the aqueous dispersion.

6. The method of claim 1, where depositing the nanomaterial in the aqueous dispersion includes depositing silver nanowires.

7. The method of claim 1, where depositing the nanomaterial in the aqueous dispersion includes depositing carbon nanotubes.

8. The method of claim 1, where depositing the nanomaterial in the aqueous dispersion includes depositing graphene flakes or graphene ribbons.

9. The method of claim 1, where depositing the surfactant in the aqueous dispersion includes depositing sodium dodecyl sulfate in a range of from 0.2% to 2.0% by volume.

10. The method of claim 1, where the method includes collecting the nanomaterial removed from the film such that the nanomaterial is reusable in the method.

11. The method of claim 1, where washing the film includes washing with de-ionized water.

12. A method of forming an electronic device comprising:
coating a surface of a film with a soluble coating in a pattern that defines coated parts of the film and uncoated parts of the film;
heating the film to evaporate the solvent;
depositing an aqueous dispersion, comprising carbon nanotubes and a surfactant, on the defined coated and uncoated parts of the film;
washing the film to remove the soluble coating and the carbon nanotubes from the defined coated parts of the film, but not from the defined uncoated parts of the film, along with removing the surfactant from the defined coated and uncoated parts of the film; and
leaving a pattern of carbon nanotubes on the defined uncoated parts of the film that comprises at least one electronic device.

13. The method of claim 12, where leaving the pattern of carbon nanotubes that comprises the at least one electronic device includes the at least one electronic device being selected from a group that includes a conductor, a resistor, a capacitor, an inductor, and a transistor.

14. The method of claim 12, where coating the surface of the film includes the film being selected from a group that includes polyethylene terephthalate and polyethylene naphthalate.

15. A system comprising:
a film, where a surface of the film is coated in a pattern with a soluble coating in a pre-defined pattern that defines coated parts of the film and uncoated parts of the film;
a spray apparatus that deposits an aerosol dispersion of carbon nanotubes and a surfactant on the defined coated and uncoated parts of the surface of the film; and
a washing apparatus that removes the soluble coating and the carbon nanotubes deposited on the defined coated parts of the film, along with the surfactant deposited on the defined coated and uncoated parts of the film, and that leaves a pattern of carbon nanotubes on the defined uncoated parts of the film.

16. The system of claim 15, where the surface of the film is coated in the pattern with a printer, where the printer is selected from a group that includes gravure, screen, thermal inkjet, and piezoelectric inkjet printers.

17. The system of claim 15, where the surface of the film is coated in the pattern to a thickness in a range of from 1 micrometer to 15 micrometers.

18. The system of claim 15, where the spray apparatus deposits an aerosol dispersion of carbon nanotubes and a surfactant to a uniform thickness on the defined coated and uncoated parts of the surface of the film.

19. The system of claim 15, where the spray apparatus deposits an aerosol dispersion of carbon nanotubes and a surfactant to a thickness of from 2.5 to 150 nanometers.

20. The system of claim 15, where the system includes a collection apparatus that collects the removed carbon nanotubes such that the removed carbon nanotubes are reusable by the system.
